(19) United States
(12) Patent Application Publication
(10) Pub. No.: US 2003/0220773 A1
(43) Pub. Date: Nov. 27, 2003

(54) Market response modeling

(75) Inventors: Stephen M. Haas, (US); Edward Isaaks, Redwood City, CA (US); Dean Boyd, Cottage Grove, OR (US); Mary McShane-Vaughn, Fayetteville, GA (US); Robert Phillips, Palo Alto, CA (US); Michael J. Eldredge JR., Menlo Park, CA (US); Debra Kadner, (US); Yosun Denizeri, San Francisco, CA (US); Thomas E. Guardino, Eugene, OR (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics Atlanta, Inc., Rockville, MD

(21) Appl. No.: 10/356,717

(22) Filed: Feb. 3, 2003

Related U.S. Application Data
(60) Provisional application No. 60/352,878, filed on Feb. 1, 2002.
(60) Provisional application No. 60/358,732, filed on Feb. 25, 2002.

(51) Int. Cl. G06F 7/60; G06F 17/10

(52) U.S. Cl. 703/2; 705/10

(57) ABSTRACT

The present invention provides systems and related methods for forming a market response model (“MRM”) for modeling the probability of winning a price quote to a prospect or customer. Such a MRM may thereafter be used to estimate the probability of winning a bid to sell a product or service to a particular customer at a particular price against specific competition. In preferred embodiments, the process of developing a particular MRM for use in optimizing a bid entails the steps of acquiring historical data; creating an analysis data set from the historical data; exploring the data sets and identifying segments; defining an MRM structure using the segments; and validating the MRM. Embodiments of the present invention provide systems and related methods for forming a MRM for modeling the probability of winning a price quote to a prospect or customer. Such systems and methods may be used to estimate the probability of selling a product or service to a particular customer at a particular price against specific competition.

### CROSS REFERENCE TO RELATED APPLICATIONS

This application claims the benefit of priority from U.S. Provisional Patent Applications Serial No. 60/352,878, filed Feb. 1, 2002, and Serial No. 60/358,732, filed Feb. 25, 2002, the disclosures of which are hereby incorporated by reference in their entirety.

### FIELD OF THE INVENTION

The present invention relates to the creation of models for use in predicting the expected profitability of contract offers, bids, quotes, and sales pricing. More particularly, the present invention relates to systems and related methods for preparing models that take market and competitor historical data as inputs in predicting market response to custom price offers.

### BACKGROUND OF THE INVENTION

A bid is a contract proposal to a current or potential account customer for delivery of products (or services) over a specified time period at a specified price. Bids contain at least one, and may contain more than one, product or service order. For example, a bid can contain the following information: bid number, account, the description, the status, the account executive, notable dates, and one or more product orders.

In certain industries, companies bid on work to be performed on behalf of other customer companies or entities, such work typically being either the production of a product or the provision of a service on a regular basis. Such companies often competitively bid against one another for a contract, and, in making a bid for a contract or to provide a certain set of products or services, the goal is to make an optimal bid where the company balances the likelihood of winning the contract at the bid price with the profit that will be obtained if the contract is won at that bid price. In this manner, a “target price” is arrived at for a given contract.

In order to make a satisfactory bid to obtain a contract or other agreement for the provision of a product or service, a company must evaluate the aspects for the specific bid parameters that, if properly reflected in the bid price, enable the company to properly balance the likelihood of winning the bid with the profit achieved if the bid is won (otherwise known as “expected profit”). Traditionally, bid pricing has been assisted by computer systems that estimate the cost of serving individual customers, taking into account the special factors affecting the bid price. These typical cost of service-based bidding systems often compute a price floor or minimum bid for a prospective contract or agreement based on the cost of delivering the products or services while the actual calculation of profit for the contract is subjectively later added on by the company. Consequently, while the traditional cost of service-based bidding systems can provide guidance on the minimum bid, they provide no guidance for the optimal way to balance the likelihood of winning the bid with the profit achieved if the bid is won. This guidance can only be provided if a target price is established that balances the likelihood of winning the bid with the profit achieved if the bid is won by maximizing the expected profit that is achieved by the target price.

Traditional cost of service-based bidding systems have a number of drawbacks as they typically lack the ability to factor the market response of customers and competitors into pricing decisions. This is mainly due to the fact that such pricing tools and system are cost-focused even though clients may increasingly demand products and services that are tailored to their specific needs. The traditional cost of service-based bidding systems also lack the ability to track and analyze post-bid information, such as interim bid wins and bid losses, the profitability of won bids, and otherwise capture useful data which can be analyzed for the generation of future bids.

Thus, there remains a need in the art for a method of establishing market response models useful when carrying out optimization analyses for target and bid pricing where such models take market and competitor response characteristics into account. There is a further need in the art for bid pricing method that takes market and competitor response characteristics into account via a market response model when generating bids for portfolios of products and services to be provided or performed over extended contract periods.

### SUMMARY OF THE INVENTION

In light of the deficiencies described above and other deficiencies present in the art, it is an object of the present invention to provide modeling and optimization systems and related methods that enable companies to provide rapid custom quotes for each customer, deal, and/or account.

Further, it is an object of the present invention to provide modeling and optimization systems and related methods that tailor quotes to each specific competitive situation by taking into account expected market responses to pricing and bid changes.

Similarly, it is an object of the present invention to provide modeling and optimization systems and related methods that are able to accurately predict win probability and profit outcome from historical sales, bid, and/or fulfillment data.

Additionally, it is an object of the present invention to provide modeling and optimization systems and related methods that balance the likelihood of winning the business against contribution to margin to help manage the complexity of bid pricing.

Finally, it is an object of the present invention to provide modeling and optimization systems and related methods that can be fine-tuned on an ongoing basis as market response to recent developments in the relevant marketplace.

To achieve these and other objects, the present invention provides a market response model (“MRM”) determined from historical marketplace data, where the MRM may be used to predict how a given segment of a market will respond to pricing fluctuations. Such an MRM may then be used as an input to the optimization of any prospective quote or contract bid where the optimization determines the optimal “target” price that maximizes the expected profitability from offering the quote (i.e., the target price is the price that optimally balances the probability of winning the quote with the profit achieved if it is won as opposed to the price with the highest “estimated win probability,” which would mean driving the price down to the point where winning would be unprofitable).

Price quotation optimization solutions according to the present invention, preferably embodied by electronic computational systems and related methods, employ MRMs to help gauge a customer's willingness to pay a quoted price for a particular product or service bid. The MRMs are established from market segmentation and statistical regression analyses of historical bid and marketplace data. This data is acquired and segmented along various relevant market dimensions, including customer type, size, product category, current supplier, region, and other statistically significant dimensions. Using this segmentation, the market response to a custom quote, reflected by the probability of winning a bid, can be forecasted for any new bid. In this manner, a company is able to decide how to price any custom offer to any potential customer against any competition.

According to preferred embodiments of the present invention, the modeling and optimization systems and related methods implement a process for developing a particular MRM generally by acquiring historical data, creating an analysis data set from the historical data, exploring the data sets and identifying segments therein; defining an MRM structure using the segments; and validating the MRM for use in optimizing future bids. This MRM can thereafter be employed to predict how customers will respond to a custom price offer, and therefore be used as an input in selecting optimum bidding strategies.

The probabilistic results of a MRM are produced using a statistical analysis of historical data. The historical data often comes from multiple sources, and should be representative of current marketplace conditions and should include data from a mix of products and competitors. Ideally, the historical data should include a complete set of quote records (wins, losses, and partial wins) including the following information: account characteristics; quote characteristics; prior price offered; competitors; competitor offered prices; and prior quote winner.

The historical data is converted into one or more analysis data sets by applying business logic and experience to the data. This may include estimating missing (but necessary) data, deleting known outlier records in the historical data, and creating variable aggregations, transformations and summary statistics with the goal of providing the necessary information to produce an accurate MRM from the historical data set.

In segmenting the market, statistical clustering and categorization techniques are employed to determine stable and predictable market segments within the analysis data sets. If there are strategic or institutional constraints on cross-segment price differentials, these constraints can be specified and utilized for market segmentation as well, and separate MRMs can be established for each segment.

In preferred embodiments of the invention, statistical classification algorithms and analyses, such as cluster analyses, classification and regression trees (“CART”) and chi-square automatic integration detector (“CHAID”), are used to identify segments within historical data and enable stable and predictable demand patterns to be extracted from voluminous sales data in an effective manner.

Analytic regression techniques are thereafter employed to estimate the likely response to any new bid by any current or potential customer. Based on such predicted customer responses to changes in price, the system and related methods of the present invention determine optimal prices for any particular sale or bid.

In one preferred embodiment, the present invention employs a binomial logistic to determine an estimated probability of winning a bid or auction according to various predictors. Predictors can be market segmentation criteria, bid drivers, or a product of several of these. For every predictor specified by the user, the associated coefficient values that define the market response curve are estimated using data analysis and regression and stored. These coefficients are used in combination with account and bid characteristics to calculate win probabilities.

Pricing optimization systems employing MRM methods according to the present invention track customer responses to price changes or bids as they are made to continuously update the current model.

In the above manner, MRMs performs three main functions: updating the coefficients for market response predictors on the basis of historical data (which can be accepted, rejected, or altered by the user); for a particular bid, evaluating the price-independent predictors to generate a market response curve that depends only on price; and for a particular bid and offered price, calculating the estimated probability of winning (“the market response”).

In embodiments of the invention, the modeling and optimization systems can include tools that enable the win probability, or estimated probability of winning a bid at a given price, to be represented by a MRM module as a market response curve. The market response curve, which can also be called a win probability curve, is a continuous function that relates win probabilities to net prices while holding all other variables constant.

Additional features and advantages of the invention are set forth in the description that follows, and in part are apparent from the description, or may be learned by practice of the invention. The objectives and other advantages of the invention are realized and attained by the structure and steps particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings with like reference numbers representing corresponding parts throughout:

FIG. 1 is a logic diagram schematically depicting how historical data may be used to create a MRM according to embodiments of the present invention;

FIG. 2 is a flow diagram depicting an MRM creation process according to embodiments of the present invention;

FIG. 3 is a depiction of a historical data importation user interface for a MRM building tool of a modeling and optimization system according to preferred embodiments of the present invention;

FIG. 4 is a depiction of a data segmentation options user interface for a MRM building tool of a modeling and optimization system according to preferred embodiments of the present invention;

FIG. 5 is a depiction of a data segmentation output user interface for a MRM building tool of a modeling and optimization system according to preferred embodiments of the present invention;

FIG. 6a is a moving average plot of the analysis data set of the example introduced by FIG. 3, and FIGS. 6b through 6f are moving average plots of the same analysis data set as split up into various segments;

FIG. 7 is a depiction of a MRM regression output user interface for a MRM building tool of a modeling and optimization system according to preferred embodiments of the present invention; and

FIG. 8 is a depiction of a pivot table showing statistics for the analysis data records after they have been divided into various segments per the example introduced by FIG. 3.

### DETAILED DESCRIPTION OF THE PREFERRED EMBODIMENTS

Reference is now made in detail to the preferred embodiment of the present invention, examples of which are illustrated in the accompanying drawings.

The present invention provides a system, method, and software for forming a market response model (MRM) for modeling the probability of winning a price quote to a prospect or customer. In other words, a MRM may be used to estimate the probability of selling a product or service to a particular customer at a particular price against specific competition. The present invention further relates to a modeling and optimization system for performing these steps. In one embodiment, the system may include tools, templates, guidelines, and software for performing each step. Implementations of the system may include various communication and reporting mechanisms to interact with users, other systems, and data storage devices.

Preferred embodiments of the present invention include modeling and optimization systems which contain a response modeling module that is adapted to perform operations for calculating a target bid price to optimize revenues. The response modeling module provides tools and associated used interfaces to facilitate the generation of a MRM from the examination of historical bid information records, where the MRM may thereafter be utilized to calculate bid win probabilities as a function of price-related variables.

A given MRM produced by the response modeling module according preferred embodiments of the present invention define the response of the market to changes in price-related and non-price predictors or variables such that the modeling and optimization system can thereafter calculate the optimum target price for making a bid which will both be profitable to the company making the bid, and which will take into account the likely bids of other competing bidders to maximize the chance of bid success. Predictors are measurements or indicator variables used to estimate (or “predict”) the win probability for a bid. Predictors can be, for example, market segmentation criteria, bid variables, or a product of several of these. The response modeling module is adapted to build an MRM by fitting associated coefficients with identified predictors so as to define one or more win probability curves. The win probability curve, also called a market response curve, is a function of these predictors (each predictor measuring key attributes of the accounts of the bids) and their coefficients (which measure the relative weights of the predictors in estimating win probabilities). Each predictor's coefficient is calculated using suitable logistic regression routines on historical bid data. For every predictor identified by the response modeling module or specified by the user as being relevant to market response, the coefficient values that define the market response curve are estimated by the response modeling module and stored. These coefficients are used in combination with account and bid characteristics to calculate win probabilities.

In certain embodiments of the invention, the response modeling module may include routines for displaying a market response curve for each segment. The market response curve is defined by a functional form and coefficients and embodies price sensitivity (elasticity) and brand preference. Overall, a MRM provides considerable advantages in determining target pricing to achieve various business goals such as profit or sales maximization.

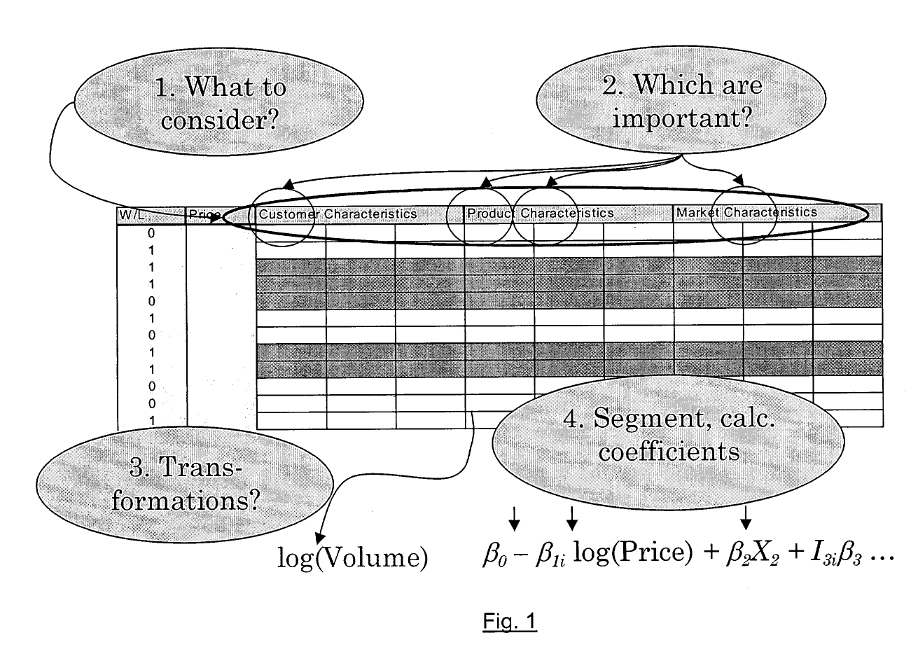

FIG. 1 is a logic diagram schematically depicting how historical data may be used to create a MRM according to embodiments of the present invention. As shown in FIG. 1, the historical data may include, for example, variables reflecting customer characteristics, product characteristics, and market characteristics. From this historical data, important predictor variables must then be identified. In determining optimal prices, a MRM may reflect multiple variables, each of which can take on a variety of functional forms or transformations. For example, the price variable could appear as an absolute price, a discount below list price, or a price ratio. Likewise, a MRM may use other variables such as volume or product mix, and each of these variables could take on a variety of transformations (such as “log (volume)” as depicted). Once the historical data has been adequately assembled and prepared, this data can then be segmented and used to calculate appropriate predictor coefficients of an MRM according to the present invention.

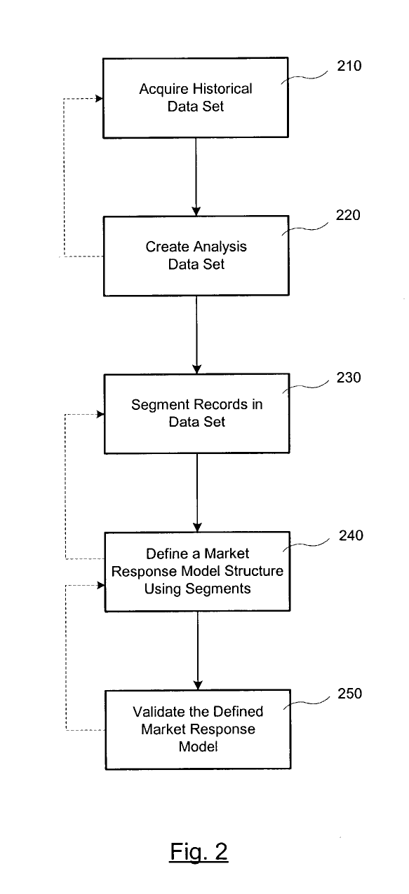

As depicted in FIG. 2, according to preferred embodiments of the present invention, the modeling and optimization systems and related methods implement a MRM creation process 200 for developing a particular MRM (process 200 also being referred to herein as a “market response modeling process”). Process 200 generally includes the steps of acquiring 210 historical data, creating 220 an analysis data set from the historical data, exploring the data sets and identifying segments 230 therein; defining 240 an MRM structure using the segments; and validating 250 the MRM for use in optimizing future bids. This MRM can thereafter be employed to predict how a given segment of a market will respond to pricing fluctuations, and therefore to select optimum bidding strategies.

As described above, the probabilistic results of a MRM are produced using a statistical analysis of historical data. In acquiring the historical data at step 210, the historical data may come from multiple sources. One requirement of the historical data is that it should be representative of current marketplace conditions and should include data from a mix of products and competitors. Ideally, the historical data should include a complete set of quote records (wins, losses, and partial wins) including the following information: account characteristics; quote characteristics; prior price offered; competitors; competitor offered prices; and prior quote winner.

After the acquiring of a complete historical data set, this data set is converted into one or more analysis data sets at step 220 by applying business logic and experience to the data. This may include estimating missing but necessary data, such as certain cost information, etc. The creation of the analysis data set may also include deleting known outlier records in the historical data, such as where the data from one or more particular records is known to be skewed due to some isolated occurrence which is unlikely to happen again in the future. During the creation of the analysis data set variable aggregations, transformations and summary statistics may be created with the goal of providing the necessary information to produce an accurate MRM from the historical data set.

After analysis data set is ready, the MRM process 200 segments the market according to the data records at step 230. In performing segmenting, the response modeling module employs statistical clustering and categorization techniques to determine stable and predictable market segments within the analysis data sets. The MRM process 200 produces segmentation of the data records into various categories or “buckets,” such as according to customer characteristics, quote characteristics, and market characteristics, to produce a subset of records having common characteristics. For instance, commonly segmented quote records may have failed or succeeded (i.e., were not accepted or accepted) because of the customer, the quote, or competitor activities. For example, it may be learned that large corporate customers located in the Northeast are less price sensitive than small corporate customers in the West. This information can be useful in guiding the direct sales force or in planning and executing promotions or in crafting bids. If there are strategic or institutional constraints on cross-segment price differentials, these constraints can be specified and utilized for market segmentation as well, and separate MRM predictor coefficients can be established for each segment.

A MRM typically segments the historical data in to various categories or buckets for analysis including, but not limited to, account tenure/relationship, Industry segment, Customer size, Region, Quote Type, Quote Size; and Competitor identity. The response modeling module may then use various relationships from these segments when predicting the probability of winning a price quote to a prospect or customer.

In preferred embodiments of the invention, statistical classification algorithms and analyses, such as cluster analyses, classification and regression trees (“CART”) and chi-square automatic integration detector (“CHAID”), are used to identify segments within historical data and enable stable and predictable demand patterns to be extracted from voluminous sales data in an effective manner. The classic CART algorithm was popularized by Breiman, Friedman, Olshen, and Stone in the early 1980s, and CART is a known algorithm that builds classification and regression trees for predicting continuous dependent variables (regression) and categorical predictor variables (classification). In one embodiment, the MRM module may incorporate commercially available data analysis software such as “CART” produced by Salford Systems of San Diego to assist in automating segmentation operations.

Taking into account the customer segmenting, analytic regression techniques are thereafter employed at step 140 on the analysis data set to define the MRM by producing a function that defines the expected probability of winning a given bid based upon various predictors. In this manner, it may be found, for example, that a 5% increase in price for the bid will result in a 2.5% decrease in expected probability of the winning bid. Based on such predicted market response, the system and related methods of the present invention determine which prices to bid for any given quote or offer.

In one preferred embodiment, the present invention employs a binomial logistic to determine an estimated probability of winning a bid or auction according to various predictors. For every predictor specified by the user, the associated coefficient values of the binomial that define the market response curve are estimated using data analysis and regression and stored. These coefficients can then be used in combination with account and bid characteristics to calculate win probabilities. In this preferred embodiment, the MRM module may estimate the probability of winning a bid or auction (Est_Win_Prob), as contained in Equation 1 below.

$$Est\_Win \_Prob = \frac{1}{\begin{matrix}1 + exp [ {β}_{0} + {\sum }_{i} {β}_{i} {I}_{i} + {γ}_{0} {f}_{1} ( Price ) + {\sum }_{i} {γ}_{i} {I}_{i} {f}_{2} ( Price ) + \\ {\sum }_{j} [ {δ}_{j , 0} {f}_{3 , j} ( {Other}_{j} ) + {\sum }_{i} [ {δ}_{j , i} {I}_{i} {f}_{4 , j} ( {Other}_{j} ) ] ]\end{matrix}} \qquad Equation 1$$

Where, in Equation 1 above:

Iᵢ represents the price segment, wherein

Iᵢ=1, if in segment i, or

Iᵢ=0, otherwise;

Price represents price-related predictor variables(s) such as absolute price, discount, ratio of absolute price to business as usual price or competitor price, etc.;

Otherⱼ represents the jth non-price predictor such as volume or percentage product mix;

f₁, f₂, f₃, and f₄ represent functional transformations, e.g., natural logarithm, of the price or non-price predictors determined as appropriate in the regression process; and

β₀, βᵢ, γ₀, γᵢ, δ_{j,0} and δ_{j,i} represent model coefficients determined as part of the process.

The β₀ term in Equation 1 serves as the constant (i.e., not dependent on price or the non-price predictors) term common to all price segments, while the βᵢ term represents the constant term that varies by price segment (thus, the index i). The γ₀ term represents the impact of price that is common to all price segments, while the γᵢ term represents the impact of price that varies by price segment. Finally, the δ_{j,0} term represents the impact of the jth non-price predictor variable that is common to all price segments; and the δ_{j,i} term represents the impact of the jth non-price predictor variable that varies by price segment.

In defining a MRM structure, various statistical metrics may be employed to identify a correct model for the MRM. For instance, a significance of fit test can be used to measure whether at least one of the model coefficients is likely different from 0. Similarly, the AKAIKE information criterion could provide a numerical comparison between two market response models. The WALD test could be used to add or reject individual predictor variables to or from the MRM or the likelihood ratio test.

In the regressions performed at step 240, coefficients can be characterized as falling into two categories: price dependent and price independent. When computing the optimal (target) price, price independent terms can be viewed as constants and computed in advance. The main inputs to this computation are: market segments, and price independent and price dependent predictors for each market segment. The main outputs are: price independent and price dependent coefficients, bid specific market response curves, and bid and price specific win probability estimates. Understandably, experience and business judgment play an important role in knowing which variables to consider at step 240 and which segmentations make sense at step 230.

The response modeling module uses the MRM defined at step 240 and know values for all price independent terms to generate a market response curve dependent only on the user's net price. Then, the modeling and optimization system can perform a non-linear optimization routine to find the price which maximizes expected contribution.

Once an MRM is established using appropriate regression techniques, the MRM is validated. Validating the MRM is generally an iterative procedure (as reflected by the dashed flow arrows in FIG. 2) where one begins by calculating the target prices and associated benefits corresponding to a particular logistic equation. Predicted benefits associated with the recommended target prices are then examined from a business perspective. If the predicted benefits are not acceptable from a business prospective, a new MRM must be defined. Typically, this means adjusting values of fixed price coefficient or other parameters used in the regression. Also, this may include adding or subtracting new predictor variables to the regression or defining new dependent interaction variables (such as profit).

Once an MRM has been found to be acceptable, the MRM module can output representations of the regression, including graphical representation such as a histogram of the ratio of target price to historical price. In this manner, the success in optimizing revenue in the contracts and transactions represented in the historical data can be analyzed.

Statistical metrics may likewise be used to assess the accuracy of a MRM during validation step 230. For instance, the Hosmer and Lemeshow goodness-of-fit test can be used to test whether the residuals between the fitted values and data are larger than can be expected and to test for over-fitting by testing whether the residuals between the fitted values and data are larger than can be expected in a hold-out or validation subset of the data. In addition, misclassification tables and concordant rates may be used to check the error rates associated with the estimated probabilities, and various bias checks may be performed to increases confidence in the accuracy of the optimized target price predictions. Statistical results related to the confidence intervals may be used to quantify the uncertainty associated with the predicted win probabilities.

Various business metrics may also be employed to assess the applicability of the MRM to current conditions. For example, a sensitivity check examines whether poor price sensitivities are due to unusually large intercepts in the MRM. Other business metrics include comparing any unconstrained target price historical and list prices for reasonableness, comparing any discounts at unconstrained target prices to the discount at historical prices for reasonableness, comparing predicted profit at target prices to the profit at historical prices for reasonableness, and comparing the proportion of bids won at target prices to the proportion won at historical prices.

In one embodiment, the some of the historical data may be summarized in the form of price curves to indicate of the predictability of price response, and of how challenging it will be to develop the MRM. In another embodiment, the results of an MRM are communicated to a user through one or more standard graphs such as price recommendation histograms that form snapshots of the price changes that result overall or by segment from the MRM.

As described above, a MRM and the results predicted therefrom are validated. For example, this validation may be communicated to users in the form of “Report Cards” containing a qualitative summary of data, model, or pricing results. Project teams, whereby each team can set its own grading curve, may establish the Report Card scores. Also, other process outputs may be directly inputted and displayed on report cards.

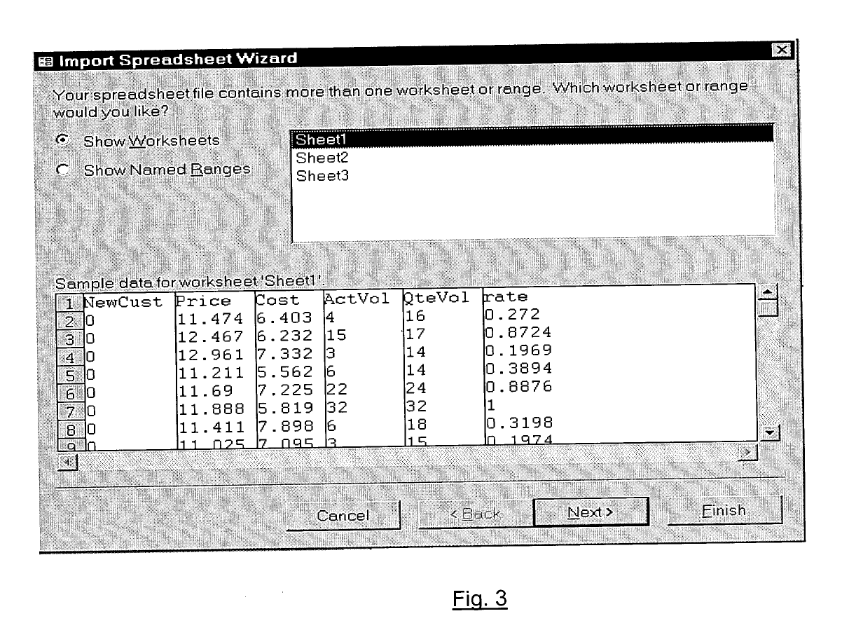

The operation of a response modeling module according to one preferred embodiment of the invention will now be described by an example of the creation of an MRM using a hypothetical historical data set. This example spans FIGS. 3 through 8. FIG. 3 depicts the importation of a historical data set, in the form of an electronically stored table, into an MRM building module. In the specific example depicted by FIG. 3, the table contains 2,000 entries, each entry having 5 attributes or variables. These attributes include, reading from left to right in FIG. 3, an indication as to whether the customer for that record is a new customer, the price for that entry, the cost associated with that entry, the actual volumes sold, the volume quoted, and the success rate. The attribute new customer is a categorical variable in that it contains a value of either 0 or 1. Price, cost, actual volume, quote volume, and rate are all continuous variables. For the particular MRM to be calculated, rate will be treated as the main target variable for segmentation.

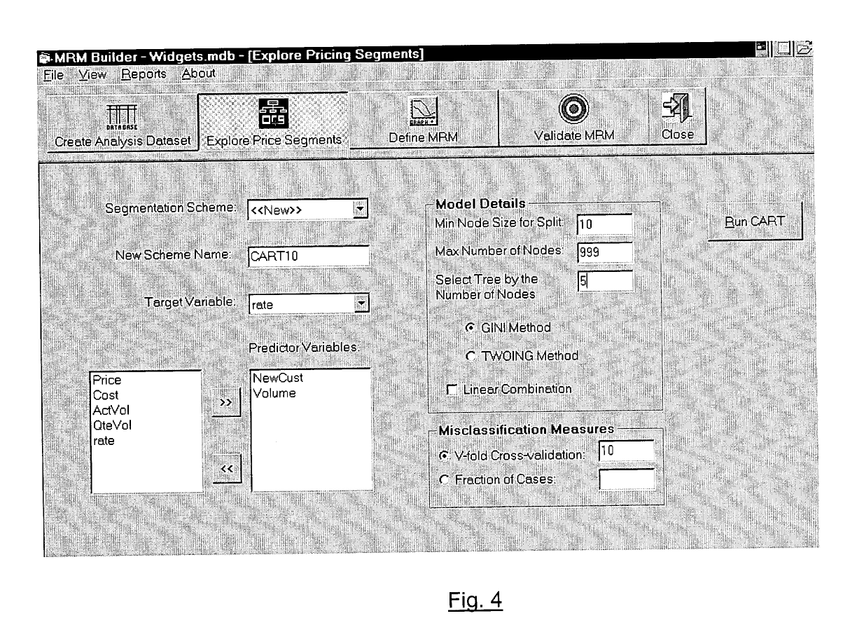

In applying segments to the analysis data set, the MRM module may employ any known and classification algorithm that can be automated readily, including CART and CHAID and preferably CART. As shown in FIG. 4, in the example of FIGS. 3 through 8, CART segmentation is performed by first identifying a target variable (in this case rate) and various predictor variables (new customer and volume) for application into the CART model. Parameter such as the minimum node size for splits, the maximum number of nodes, and a preferred number of nodes can be set to help control the output of CART algorithm. As shown in FIG. 4, v-fold cross validation can optionally be employed to increase the accuracy of segmentation by the CART model.

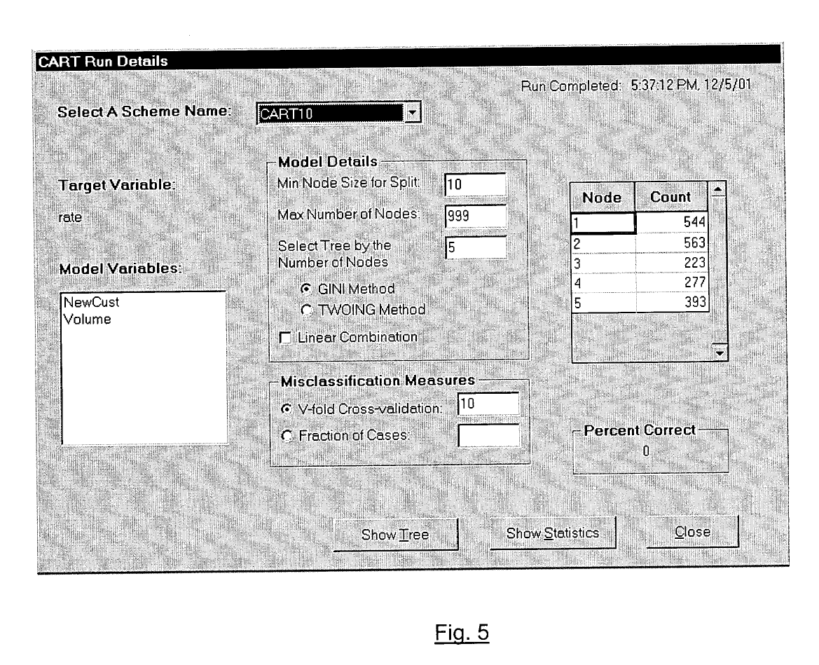

As shown in FIG. 5, the output from the CART algorithm of the MRM building module will segment the analysis data set (in the example of FIG. 3, a set of 2,000 total records) into various nodes representing segments in the data defined by the selected predictor variable. As shown in FIG. 5, five (5) nodes were identified with the largest node containing 563 entries from the original historical data set and the smallest segment containing 223 entries.

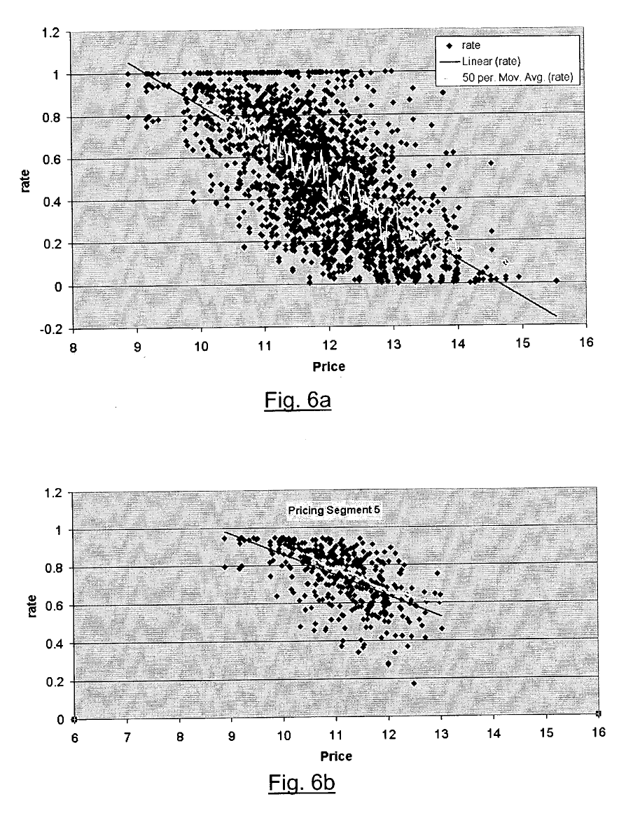

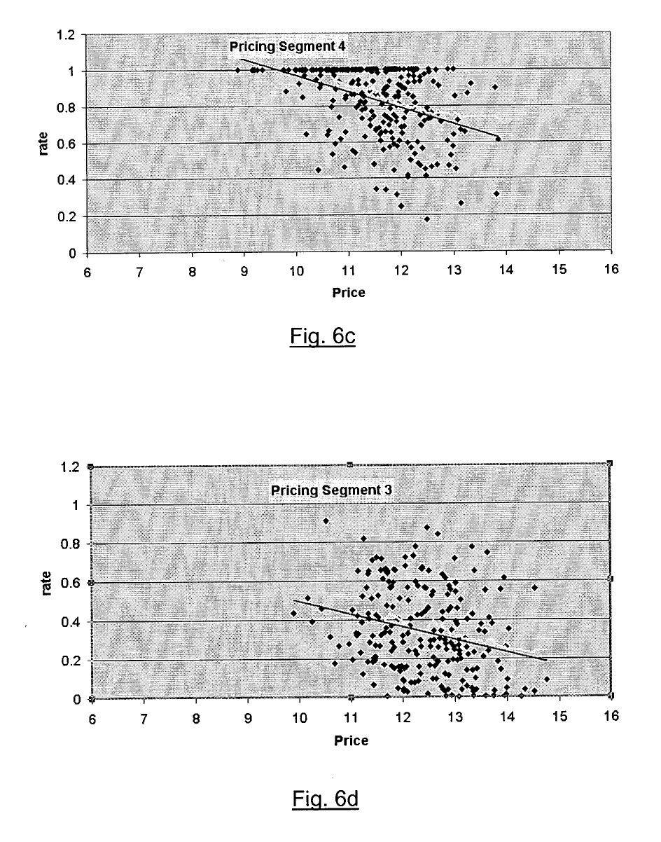

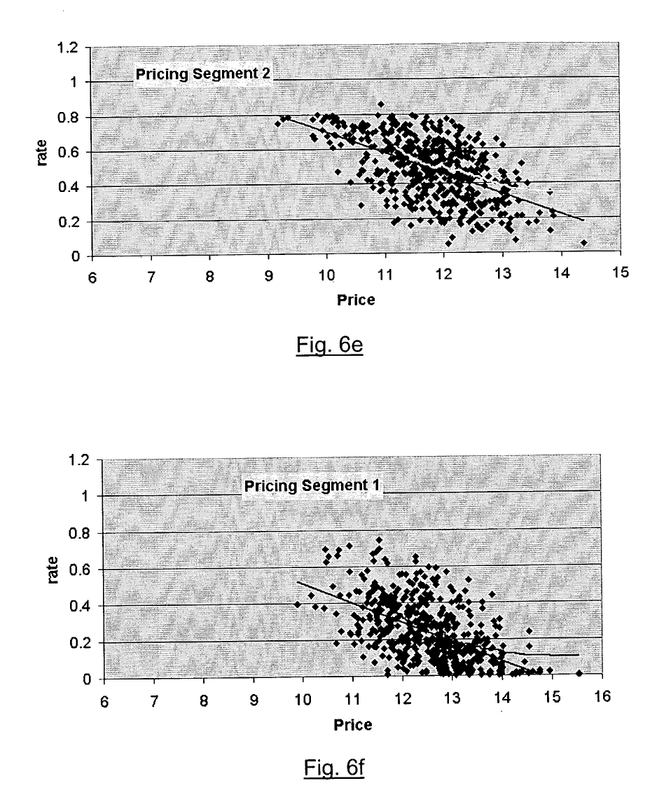

Once the segmentation algorithm has been employed to produce segments, the price sensitivity in each segment can be explored to perform a manual check on the segmenting. In embodiments in the invention, this can be performed by producing various graphs of the data falling within each segment, including average graphs of fulfillment rate versus price for each pricing segment. FIGS. 6b through 6f depict five (5) moving average graphs of fulfillment rate versus price, one for each pricing segment as identified by the CART algorithm in the example depicted in FIG. 5. It can be seen by comparing the graphs of FIGS. 6b through 6f that each segment demonstrates consistent price sensitivity producing the expected downward slope of bid win rate with increases in price. For comparison, FIG. 6a is the moving average plot for all data.

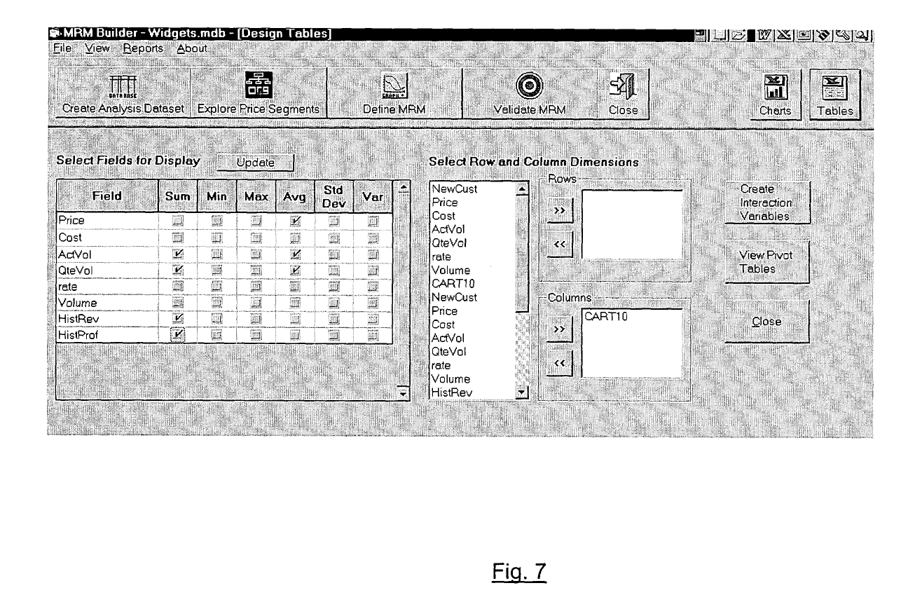

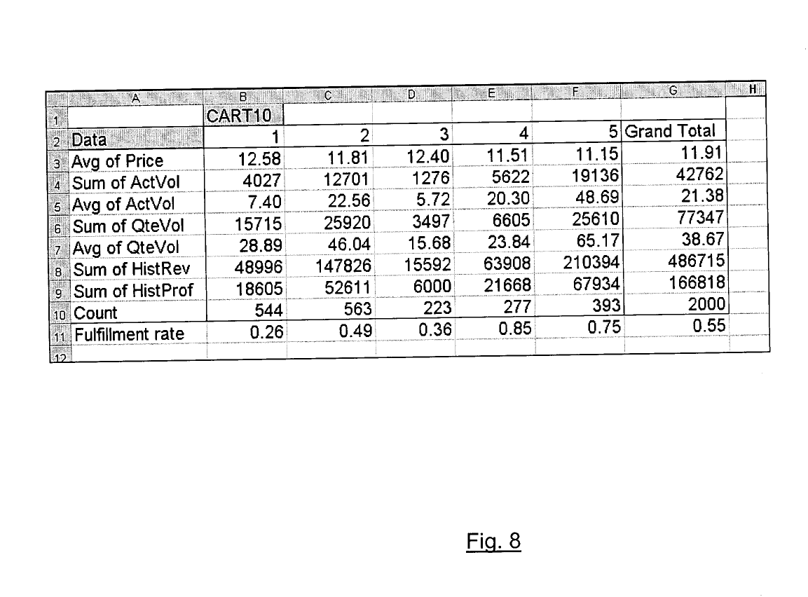

As will be readily appreciated by one of ordinary skill in the art, the historical data set does not demonstrate all of the particular variables that a business person would like to see. For example, the data set does not currently show the profit which was achieved in each entry. Generally, profit can be calculated as the difference between price and cost times the actual volumes sold. According to embodiments of the present invention, new “dependent” variables can be defined and created at any time, such as during the creation of the analysis data set or after the segmentation of data, to help in exploring pricing segments. As shown in FIG. 7, the new dependent variables “historic revenue” and “historic, profit” have been defined as functions of the original parameters contained in the various records of the acquired historical data set. Thereafter, by selecting appropriate fields as shown in FIG. 7, various pivot tables can be created and displayed to assist business persons in exploring the identified segments. FIG. 8 depicts a pivot table showing some of the interesting historical statistics for each of the pricing segments as determined above. (Note: the fulfillment rates shown at the bottom of the pivot table is a calculation made by dividing the sum of actual volume by the sum of the quote volume.) By reviewing the pivot table in the segmentation tree that defines the five (5) segments of the current example, different business information is summarized in a digestible form and informed observations can be made by a business decision maker with respect to the various segments. For example, for pricing segment number 1 (which incidentally older, established customers), the average quote volume is 28 units per quote with a low fulfillment rate of 26%. The quotes falling within this segment, however, correspond to 27% of the total number of quotes and generates approximately 11% of the total profit generated from all segments. In light of this information, this pricing segment presents an opportunity for increased profits with price optimization because the current fulfillment rate is poor and the segment represents a significant portion of total business as evidence in the historical data. Pricing segment number 5 also corresponds to older, established customers and the entries within segment 5 represent 19.5% of the total number of quotes. Segment number 5 also shows an average fulfillment rate which is relatively high at 75% within also relatively high average quote volume of 48.7 units per quote. The profit generated by these customers represents 41% of the total profit generated by all of the pricing segments; thus, these customers are very significant to the business represented by the historical data.

One of the advantages of using a CART algorithm to segment the quote data is that the task of variable selection becomes simplified. First, the CART algorithm provides a rank order list of the importance of the variables. Understandably, this list is useful in determining which variables will be relevant for logistic regression in the MRM. Second, the tree generated by the CART algorithm often exhausts the explanatory powers of the predictor variables utilized to build the tree. Thus, predictor variables used to build the CART tree generally do not need to be regressed in a subsequent logistic equation to produce a MRM.

With respect to the logistic equation, it should be obvious that one will ordinarily want to include price as a predictor variable as this is typically the main variable which is most often varied when making bids or listing products for sale. Additionally, from the example of FIG. 3, cost and volume are also included as predictor variables. These variables will be beneficial to control the bias on the predicted profit, particularly when the price coefficient is fixed in the offset method of regression.

Although the present invention is preferably implemented in an electronic environment and may involve operations performed by software, this is not a limitation of the present invention as those of ordinary skill in the art can appreciate that the present invention can be implemented in hardware or in various combinations of hardware and software, without departing from the scope of the invention. Modifications and substitutions by those of ordinary skill in the art are considered to be within the scope of the present invention, which is not to be limited except by the claims that follow.

The foregoing description of the preferred embodiments of the present invention has been presented for the purposes of illustration and description. It is not intended to be exhaustive or to limit the invention to the precise form disclosed. It will be apparent to those of ordinary skill in the art that various modifications and variations can be made to the disclosed embodiments and concepts of the present invention without departing from the spirit or scope of the invention. Thus, it is intended that the present invention covers the modifications and variations of this invention provided that they come within the scope of any claims and their equivalents.

What is claimed is:

1. A method for statistically modeling a market, the method comprising the steps of:
acquiring historical data related to said market;
creating an analysis data set from said historical data;
segmenting said analysis data set, said segmenting identifying predictable segments of the market; and
defining a market response model using said segmented analysis data set, wherein said market response model provides a probability of winning a bid at a particular price and wherein a non-linear regression is used to define said market response model according to a binomial logistic.

2. The method of claim 1 further comprising the step of validating the defined market response model.

3. The method of claim 1 further comprising the step of using the market response model to determine an optimal price for a bid.

4. The method of claim 1 wherein said non-linear regression uses at least one price-related predictor and non-price predictors.

5. The method of claim 1 wherein said market data comprises historic data representative of marketplace conditions.

6. The method of claim 5 wherein said historical data includes data on a competitor.

7. The method of claim 1 wherein said creating of said analysis data set from said historical data includes data comprises one of deleting outlier records, estimating missing data, or defining new combination variables.

8. The method of claim 5 wherein the historical data is a set of quote records selected from a group consisting of:
account characteristics;
quote characteristics;
prior price offered;
competitors;
competitor offered prices; and
prior quote winner.

9. The method of claim 1 wherein said the step of creating an analysis data set further comprises applying business logic and experience to examine the market data.

10. The method of claim 1 wherein said creating of said analysis data set from said historical data includes data comprises applying business logic and experience to examine the market data and create variable aggregations, transformation, and summary statistics.

11. The method pf claim 1, wherein the step of segmenting said analysis data set further comprises employing statistical clustering and categorization techniques.

12. The method of claim 13 wherein the step of segmenting said analysis data set further comprises using classification and regression trees (CART).

13. The method of claim 13 wherein the step of segmenting said analysis data set further comprises using Chi-squared automatic integration detector (CHAID).

14. The method of claim 1, wherein the step of segmenting said analysis data set further comprises specifying and using strategic and institutional constraints on cross-section price differentials.

15. The method of claim 1, wherein said non-linear regression employs a binomial logistic to define estimated win probability according to the definition:
$$\frac{1}{1 + exp [ {β}_{0} + {\sum }_{i} {β}_{i} {I}_{i} + {γ}_{0} {f}_{1} ( Price ) + {\sum }_{i} {γ}_{i} {I}_{i} {f}_{2} ( Price ) + {\sum }_{j} [ {δ}_{j , 0} {f}_{3 , j} ( {Other}_{j} ) + {\sum }_{i} [ {δ}_{j , i} {I}_{i} {f}_{4 , j} ( {Other}_{j} ) ] ]}$$
where, Iᵢ represents the price segment, wherein
Iᵢ=1, if in segment i, or
Iᵢ=0, otherwise;
Price represents price-related predictor variables(s) such as absolute price, discount, ratio of absolute price to business as usual price or competitor price, etc.;
Otherⱼ represents the jth non-price predictor such as volume or percentage product mix;
f₁, f₂, f₃, and f₄ represent functional transformations, e.g., natural logarithm, of the price or non-price predictors determined as appropriate in the regression process; and
β₀,βᵢ, γ₀, γᵢ, δ_{j,0} and δ_{j,i} represent model coefficients determined as part of the process.

16. A modeling and optimization system for determining the probability of winning a prospective bid to perform services or sell products, the system comprising a response modeling module adapted to allow a user to:
receive input of historical data related to a relevant market;
manipulate said historical data to create an analysis data set from said historical data;
segment said analysis data set so as to identify predictable segments of the market; and
define a market response model using said segmented analysis data set, wherein said response modeling module calculates a model for estimating a probability of winning a bid at a particular price and wherein a non-linear regression is used to define said market response model according to a binomial logistic.

17. The system of claim 16, wherein said response modeling module is further adapted to allow the user to validate the defined market response model according to business rules.

18. The system of claim 16, wherein said response modeling module allows the user to create said analysis data set from said historical data by one of deleting outlier records, estimating missing data, creating variable aggregations, creating variable transformations, or creating variable summary statistics.

19. The system of claim 16, wherein said response modeling module allows the user to segmenting said analysis data set by employing statistical clustering and categorization techniques selected from the group consisting of cluster analyses, classification and regression trees (CART), and Chi-squared automatic integration detector (CHAID).

20. The system of claim 16, wherein said non-linear regression employs a binomial logistic to define estimated win probability according to the definition:
$$\frac{1}{1 + exp [ {β}_{0} + {\sum }_{i} {β}_{i} {I}_{i} + {γ}_{0} {f}_{1} ( Price ) + {\sum }_{i} {γ}_{i} {I}_{i} {f}_{2} ( Price ) + {\sum }_{j} [ {δ}_{j , 0} {f}_{3 , j} ( {Other}_{j} ) + {\sum }_{i} [ {δ}_{j , i} {I}_{i} {f}_{4 , j} ( {Other}_{j} ) ] ]}$$
where, Iᵢ represents the price segment, wherein
Iᵢ=1, if in segment i, or
Iᵢ=0, otherwise;
Price represents price-related predictor variables(s) such as absolute price, discount, ratio of absolute price to business as usual price or competitor price, etc.;
Otherⱼ represents the jth non-price predictor such as volume or percentage product mix;
f₁, f₂, f₃, and f₄ represent functional transformations, e.g., natural logarithm, of the price or non-price predictors determined as appropriate in the regression process; and
β₀, βᵢ, γ₀, γᵢ, δ_{j,0} and δ_{j,i} represent model coefficients determined as part of the process.
